(19) United States
(12) Patent Application Publication
(10) Pub. No.: US 2012/0255416 A1
(43) Pub. Date: Oct. 11, 2012

(54) Circular saw guide

(76) Inventor: Leroy Rellergert, Perryville, MO (US)

(21) Appl. No.: 13/066,245

(22) Filed: Apr. 8, 2011

(51) Int. Cl. B27B 9/04

(52) U.S. Cl. 83/829

(57) ABSTRACT

A circular saw guide is disclosed which comprises a first guide member having a guide edge for positioning against a circular saw for cutting a workpiece and a second guide member having a guide edge for positioning against a workpiece to be cut, the second guide member being connected to the first guide member and being movable relative to the first guide member.

### BACKGROUND

This disclosure relates to a saw guide, and more particularly to a saw guide for use with a circular saw.

Wood panels, such as plywood panels, are available in various dimension such as four feet by eight feet or four feet by ten feet. Wood panels are also available in various thicknesses such as ¼ inch, ⅜ inch, ½ inch, or one inch. Table saws are typical machines used by carpenters to rip or cut wood panels. However, table saws may be difficult to move or transport to a particular work site. In this case, circular saws are common tools used by carpenters to rip or cut wood panels to a desired dimension. For example, a four foot by eight foot panel may be required to be cut in half so that two panels each having dimensions of two feet by eight feet result. Because the carpenter loses accuracy when a table saw is not used, in order to cut the panel with a circular saw various saw guides have been developed. One type of saw guide is a device that attaches to a circular saw to guide the circular saw along a panel. However, since circular saws have various sizes, it may be difficult to attach the circular saw to this type of saw guide. Another type of saw guide is a device such as a straight edge that clamps to the panel to provide an edge along which a circular saw is passed. Although useful, such device takes time to set up and if the measurement of the set up is off then the panel is cut to the incorrect size.

The present construction is designed to obviate and overcome many of the disadvantages and shortcomings associated with prior saw guide devices. In particular, there is a need for a universal circular saw guide in which the saw does not attach to the guide itself and can be quickly used. The present disclosure provides a circular saw guide that does not require the circular saw to be mounted to the saw guide. The present disclosure also provides a circular saw guide that has a guiding structure that is versatile for adapting to any circular saw and any sized panel to be cut.

### SUMMARY

In one form of the present disclosure, a circular saw guide comprises a first guide member having a guide edge for positioning against a circular saw for cutting a workpiece and a second guide member having a guide edge for positioning against a workpiece to be cut, the second guide member being connected to the first guide member and being movable relative to the first guide member.

In another form of the present disclosure, a circular saw guide for guiding a circular saw along a workpiece for cutting a workpiece is disclosed in which the circular saw guide comprises a first guide member having a body having a guide edge for positioning against a circular saw when cutting a workpiece, and a handhold formed in the body and a second guide member having a body having a guide edge for positioning against a workpiece for guiding the second guide member along a workpiece, the second guide member being connected to the first guide member and being repositioned relative to the first guide member.

In yet another form of the present disclosure, a circular saw guide for guiding a circular saw along a workpiece for cutting a workpiece is disclosed in which the circular saw guide comprises a first guide member having a body having a guide edge for positioning against a circular saw when cutting a workpiece, and a visual slot formed in the body along the guide edge and a second guide member having a body having a guide edge for positioning against a workpiece for guiding the second guide member along a workpiece, the second guide member being connected to the first guide member and being repositioned relative to the first guide member.

In light of the foregoing comments, it will be recognized that the present disclosure provides a circular saw guide which is of simple construction and design and which can be easily employed with highly reliable results.

The present disclosure provides circular saw guide that is versatile and adjustable and may be used with any existing circular saw.

The present disclosure provides a circular saw guide that is capable of being manufactured using commonly available components that are relatively inexpensive and lightweight.

The present disclosure provides a circular saw guide that does not require the circular saw to be modified or to be attached to the circular saw guide.

The present disclosure provides a circular saw guide that can be easily employed to cut a wood panel of a standard size or of any size.

The present disclosure provides a circular saw guide that is strong, reliable, durable, and easily adjustable.

The present disclosure provides circular saw guide that can be easily transported, and is collapsible for storage in a small space.

The present disclosure will become apparent after considering the following detailed specification in conjunction with the accompanying drawings, wherein:

### BRIEF DESCRIPTION OF THE DRAWINGS

FIG. 1 is a top perspective view of an embodiment of a circular saw guide constructed according to the present disclosure;

FIG. 2 is a top perspective view of a first guide member of the circular saw guide constructed according to the present disclosure;

FIG. 3 is a top perspective view of a second guide member of the circular saw guide constructed according to the present disclosure;

FIG. 4 is a top perspective view of an embodiment of a circular saw guide constructed according to the present disclosure in an adjusted position;

FIG. 5 is a partial cross sectional view of a circular saw guide constructed according to the present disclosure positioned against a workpiece and a circular saw;

FIG. 6 is a partial cross sectional view of a circular saw guide constructed according to the present disclosure showing a connection assembly; and

FIG. 7 is a side perspective view of a circular saw guide constructed according to the present disclosure shown in another cutting position.

### DETAILED DESCRIPTION

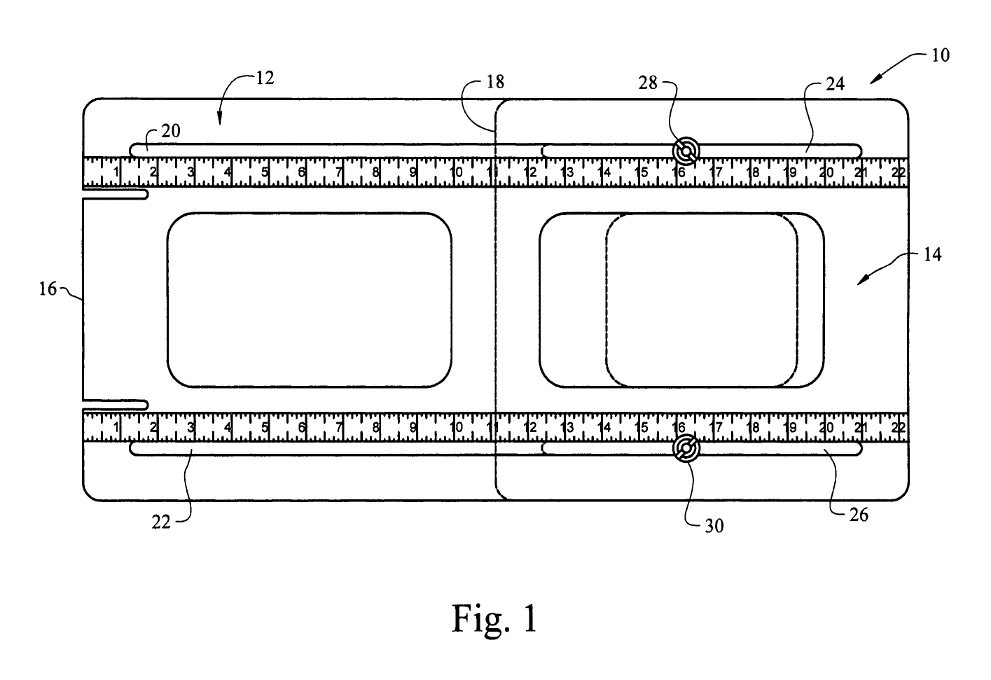

Referring now to the drawings, wherein like numbers refer to like items, number 10 identifies an embodiment of a circular saw guide constructed according to the present disclosure. With reference now to FIG. 1, the circular saw guide 10 is shown comprising a first guide member 12 and a second guide member 14. The first guide member 12 has a guide edge 16 for placement against a circular saw (not shown) for cutting a panel, piece of wood, or a workpiece. The second guide member 14 has a guide edge 18 for positioning against a panel, a piece of wood, or a workpiece to be cut. The first guide member 12 has a first slot 20 and a second slot 22. The second guide member 14 has a first slot 24 and a second slot 26. The slots 20 and 22 are adapted to be in alignment with the slots 24 and 26. The first guide member 12 and the second guide member 14 are connected to each other by use of a first connection assembly 28 mounted in the slots 20 and 24 and a second connection assembly 30 mounted in the slots 22 and 26. As will be explained more fully herein, the connection assemblies 28 and 30 may be loosened or tightened to move the guide members 12 and 14 relative to each other or to secure or hold the guide members 12 and 14 together. In this manner, the second guide member 14 is movable or adjustable relative to the first guide member 12.

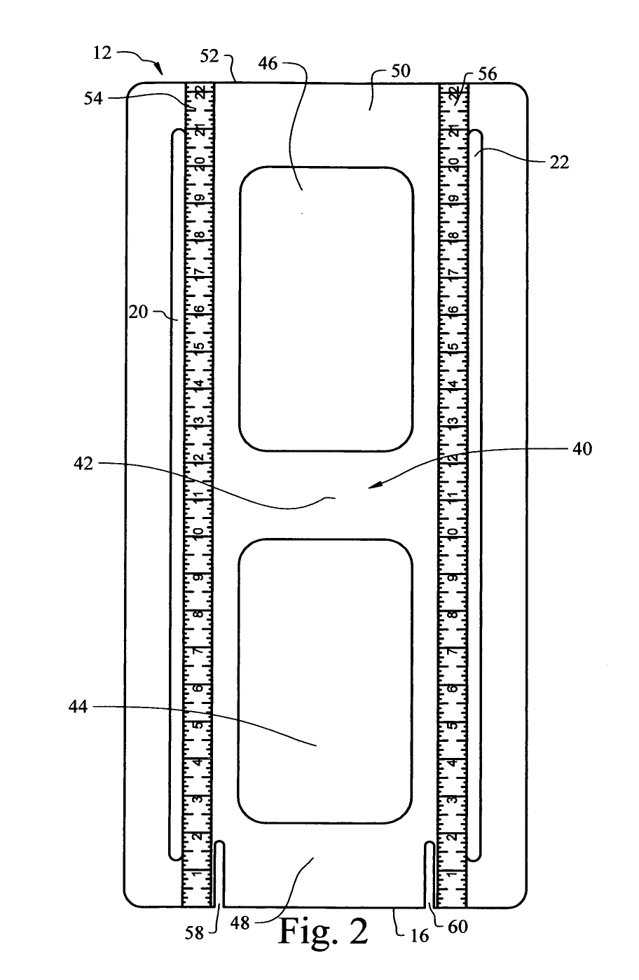

With reference to FIG. 2, the first guide member 12 is shown being separated from the second guide member 14. The first guide member 12 is generally rectangular in shape and may be constructed of a clear plastic or other available or suitable material. The first guide member 12 comprises the guide edge 16, the pair of slots 20 and 22, a body 40, and a handhold or gripping portion 42. A pair of openings 44 and 46 are formed in the body 40 with the handhold 42 formed between the pair of openings 44 and 46. A first gripping portion 48 is formed between the guide edge 16 and the opening 44. A second gripping portion 50 is also formed between the opening 46 and a back edge 52. Depending upon how the guide 10 is orientated, the back edge 52 may also serve as a guide edge. The body 40 may also have either formed therein or placed thereon a pair of measuring guides or rulers, such as tape measures 54 and 56. The tape measures 54 and 56 assist in the correct placement of the guide 10 along a workpiece (not shown). The first guide member 12 also has a first visual slot 58 formed in the body 40 along the guide edge 16. The first guide member 12 also has a second visual slot 60 formed in the body 40 along the guide edge 16. The visual slots 58 and 60 are for parallel alignment of the guide members 12 and 14 when the slots 20 and 22 are no longer available to view the edge 18 of the second guide member 14, when aligning the guide members 12 and 14, parallel to each other, such as when the second guide member 14 goes beyond the slots 20 and 22 of the first guide member 12.

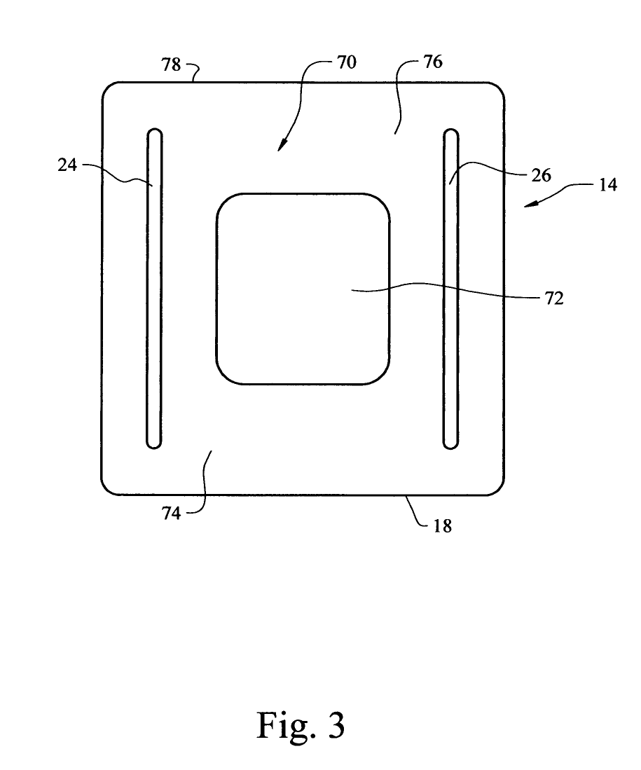

FIG. 3 depicts the second guide member 14 being separated from the first guide member 12. The second guide member 14 is generally rectangular in shape and may be constructed of a clear plastic or other available or suitable material. The second guide member 14 comprises the guide edge 18, a body 70 having a central opening 72 and the pair of slots 24 and 26. A first gripping portion 74 is formed between the guide edge 18 and the central opening 72. A second gripping portion 76 is also formed between the central opening 72 and a back edge 78. Depending upon how the guide 10 is orientated, the back edge 78 may also serve as a guide edge that may be orientated next to a workpiece (not shown).

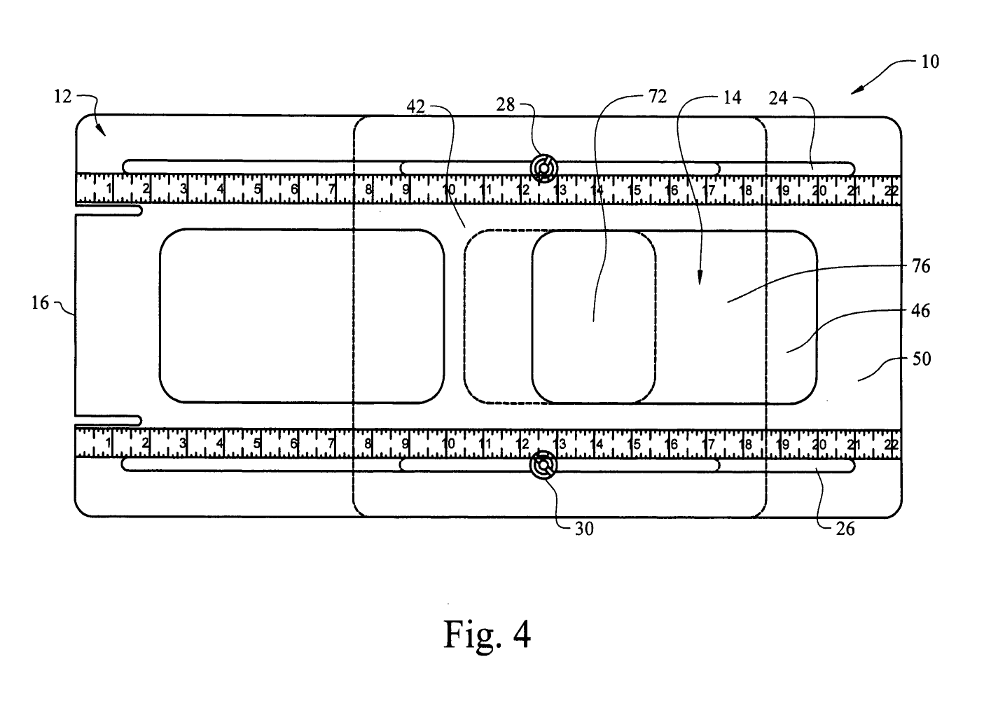

With reference now to FIG. 4, the circular saw guide 10 is shown in an adjusted position in which the second guide member 14 has been repositioned or moved relative to the first guide member 12. The first guide member 12 is on top of the second guide member 14. In this orientation, the circular saw guide 10 may be grasped using the handhold 42, the gripping portion 50, or the gripping portion 76. As the second guide member 14 is repositioned relative to the first guide member 12, various other gripping portions are available.

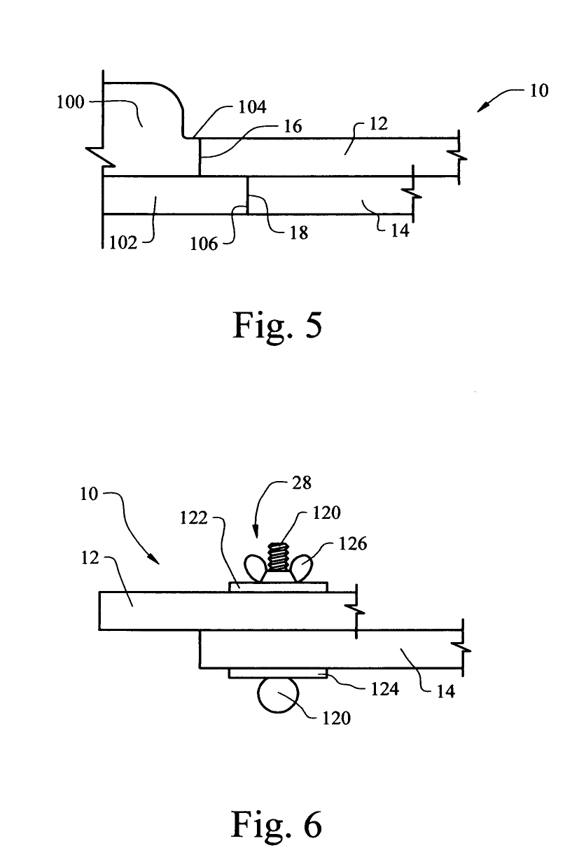

FIG. 5 illustrates the circular saw guide 10 being positioned against a circular saw 100 and a workpiece 102 to be cut. The circular saw 100 has a skid plate 104 which is positioned against the guide edge 16 of the first guide member 12. The workpiece 102 has an edge 106 which is positioned against the guide edge 18 of the second guide member 14. In this manner, the circular saw 100 and the circular saw guide 10 may be moved simultaneously when cutting the workpiece 102.

Referring now to FIG. 6, the connection assembly 28 is shown in detail securing or holding together the first guide member 12 relative to the second guide member 14. The connection assembly 28 comprises a thumb screw 120, a first washer 122 which abuts the first guide member 12, a second washer 124 which abuts the second guide member 14, and a wing nut 126. The wing nut 126 is tightened or loosened around the thumb screw 120 to either secure or hold the second guide member 14 to the first guide member 12 or to allow the second guide member 14 to be repositioned relative to the first guide member 12. The connection assembly 30 consists of the same elements. Other connecting or securing mechanisms or devices are possible and contemplated such as, by way of example only, a thumbscrew and a wing nut, a bolt and a nut, or a screw and a nut, or other similar fastening devices.

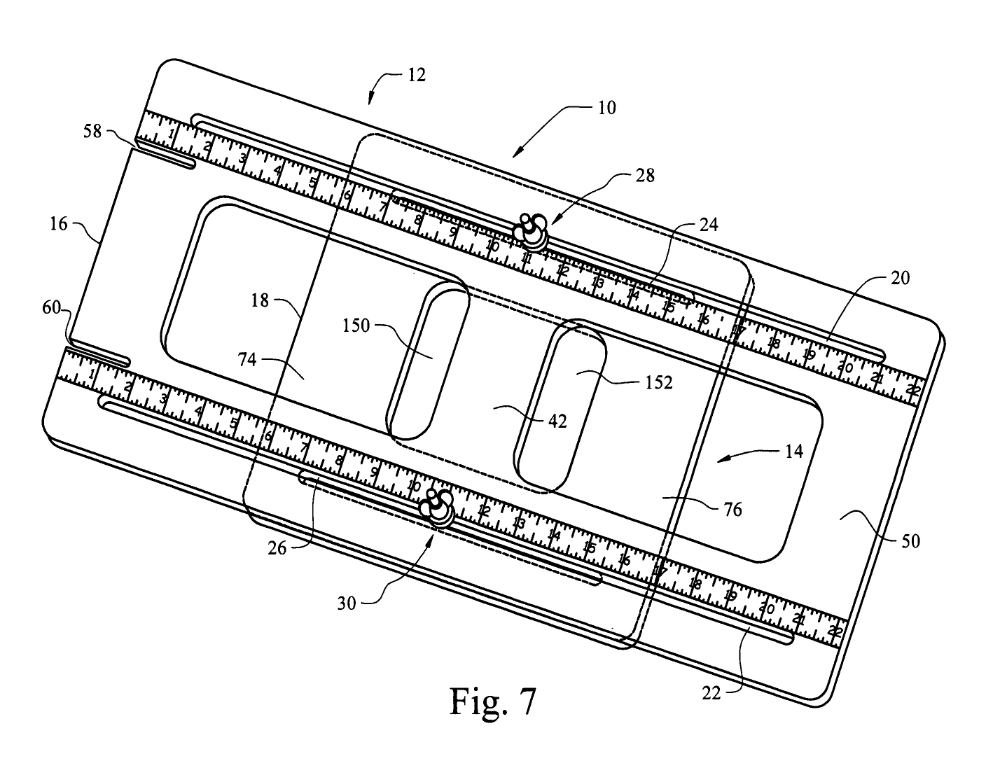

FIG. 7 illustrates a side perspective view of the circular saw guide 10. The circular saw guide 10 comprises the first guide member 12 and the second guide member 14 which are movable relative to each other. The first guide member 12 has the guide edge 16 for placement against a circular saw (not shown) for cutting a panel, a piece of wood, or a workpiece. The second guide member 14 has the guide edge 18 for positioning against a panel, a piece of wood, or a workpiece to be cut. The first guide member 12 has the first slot 20 and the second slot 22. The second guide member 14 has the first slot 24 and the second slot 26 which are in alignment with the slots 20 and 22. The first guide member 12 and the second guide member 14 are connected to each other by use of the first connection assembly 28 mounted in the slots 20 and 24 and the second connection assembly 30 mounted in the slots 22 and 26. Although two connection assemblies 28 and 30 are shown, it is possible and contemplated to use more connection assemblies. As has been previously explained, the connection assemblies 28 and 30 may be loosened or tightened to move the guide members 12 and 14 relative to each other or to secure or hold the guide members 12 and 14 together. In this manner, the second guide member 14 is movable or adjustable relative to the first guide member 12 to position the guide edge 18 against a piece of wood to be cut and to place the guide edge 16 against a circular saw. In this particular orientation the circular saw guide 10 can be grasped at various locations. For example, the circular saw guide 10 may be grasped using the handhold 42 of the first guide member 12, the gripping portion 50 of the first guide member 12, the gripping portion 74 of the second guide member 14, or the gripping portion 76 of the second guide member 14. Also in this particular configuration, a pair of areas 150 and 152 are formed for allowing the handhold 42 to be easily grasped. Further, the visual slots 58 and 60 are shown overlapping the slots 20 and 22 by about a quarter of an inch or a half inch. As previously indicated, the visual slots 58 and 60 are for parallel alignment of the guide members 12 and 14 when the slots 20 and 22 are no longer available to view the edge 18 of the second guide member 14. Although the guide members 12 and 14 are illustrated as being formed of a clear plastic, it is also possible that the guide members 12 and 14 may be formed of an opaque material such as aluminum. In this manner, the visual slots 58 and 60 are particularly useful for parallel alignment of the guide members 12 and 14.

The circular saw guide 10 operates as follows. The width of the workpiece 102 that needs to be cut is determined. Once this width is determined, the first guide member 12 is placed over the workpiece 102. The width of the first guide member 12 that is placed over the workpiece 102 is equal to the width of the workpiece 102 that needs to be cut less the distance from the edge of the skid plate 104 to the cutting blade. The guide edge 18 of the second guide member 14 is then moved up next to the edge 106 of the workpiece 102. The connection assemblies 28 and 30 are then tightened to secure the second guide member 14 to the first guide member 12. The skid plate 104 of the circular saw is then placed against the guide edge 16 of the first guide member 12. Once in position, the circular saw 100 is turned on and both the circular saw 100 and the saw guide 10 are moved in unison against the edge 106 of the workpiece 102 to cut the workpiece. Once the workpiece 102 has been cut, the circular saw 100 is turned off. The circular saw guide can then be used to cut another workpiece 102 or panel. As can be appreciated, the circular saw guide 10 may be positioned in a storage configuration by having the first guide member 12 cover the second guide member 14 and tightening the connection assemblies 28 and 30. Examples of this configuration are shown in FIGS. 1, 7, and 8. In any of these configurations, the circular saw guide 10 may be easily carried, transported, and stored.

From all that has been said, it will be clear that there has thus been shown and described herein a circular saw guide. It will become apparent to those skilled in the art, however, that many changes, modifications, variations, and other uses and applications of the subject circular saw guide are possible and contemplated. All changes, modifications, variations, and other uses which do not depart from the spirit and scope of the subject circular saw guide are deemed to be covered by the disclosure, which is limited only by the claims which follow.

What is claimed is:

1. A circular saw guide comprising:
a first guide member having a guide edge for positioning against a circular saw for cutting a workpiece; and
a second guide member having a guide edge for positioning against a workpiece to be cut, the second guide member being connected to the first guide member and being movable relative to the first guide member.

2. The circular saw guide of claim 1 wherein the first guide member further comprises a pair of slots.

3. The circular saw guide of claim 2 wherein the second guide member further comprises a pair of slots which are in alignment with the pair of slots of the first guide member.

4. The circular saw guide of claim 3 further comprising a pair of connection assemblies inserted into the pairs of slots of the first and second guide members for holding the first and second guide members together.

5. The circular saw guide of claim 1 wherein the first guide member is positioned over the second guide member.

6. The circular saw guide of claim 1 wherein the first guide member further comprises a gripping portion.

7. The circular saw guide of claim 1 wherein the second guide member further comprises a gripping portion.

8. The circular saw guide of claim 1 wherein the first guide member further comprises a pair of gripping portions.

9. A circular saw guide for guiding a circular saw along a workpiece for cutting a workpiece, the circular saw guide comprising:
a first guide member having a body having a guide edge for positioning against a circular saw when cutting a workpiece, and a handhold formed in the body; and
a second guide member having a body having a guide edge for positioning against a workpiece for guiding the second guide member along a workpiece, the second guide member being connected to the first guide member and being repositioned relative to the first guide member.

10. The circular saw guide of claim 9 wherein the first guide member further comprises a pair of slots.

11. The circular saw guide of claim 10 wherein the second guide member further comprises a pair of slots which are in alignment with the pair of slots of the first guide member.

12. The circular saw guide of claim 11 further comprising a pair of connection assemblies inserted into the pairs of slots of the first and second guide members for holding the first and second guide members together.

13. The circular saw guide of claim 12 wherein the pair of connection assemblies may be loosened to slide the second guide member relative to the first guide member.

14. The circular saw guide of claim 9 wherein the second guide member has a central opening over which the handhold is positioned.

15. The circular saw guide of claim 9 wherein the first guide member further comprises a first gripping portion and a second gripping portion.

16. A circular saw guide for guiding a circular saw along a workpiece for cutting a workpiece, the circular saw guide comprising:
a first guide member having a body having a guide edge for positioning against a circular saw when cutting a workpiece, and a visual slot formed in the body along the guide edge; and
a second guide member having a body having a guide edge for positioning against a workpiece for guiding the second guide member along a workpiece, the second guide member being connected to the first guide member and being repositioned relative to the first guide member.

17. The circular saw guide of claim 16 wherein the first guide member further comprises a pair of slots.

18. The circular saw guide of claim 17 wherein the second guide member further comprises a pair of slots which are in alignment with the pair of slots of the first guide member.

19. The circular saw guide of claim 18 further comprising a pair of connection assemblies inserted into the pairs of slots of the first and second guide members for holding the first and second guide members together.

20. The circular saw guide of claim 16 wherein the first guide member further comprises a tape measure.
